(19) United States
(12) Patent Application Publication
(10) Pub. No.: US 2022/0387929 A1
(43) Pub. Date: Dec. 8, 2022

(54) SYSTEMS AND METHODS FOR HARVESTING WATER FROM AIR

(71) Applicant: Comstock IP Holdings LLC, Milton, GA (US)

(72) Inventors: Craig A. Grimes, Raleigh, NC (US); Kevin Kreisler, Miami, FL (US); Scott C. Kreisler, Sugar Hill, GA (US)

(21) Appl. No.: 17/824,343

(22) Filed: May 25, 2022

Related U.S. Application Data
(60) Provisional application No. 63/193,826, filed on May 27, 2021.

(51) Int. Cl. B01D 53/26; B64C 23/08; B64C 3/14

(52) U.S. Cl. CPC B01D 53/265; B64C 23/08; B64C 3/14; B01D 2257/80

(57) ABSTRACT

An integrated system for harvesting water from air includes an air propelling unit, a water condensation unit, and a fog harvester. The water condensation unit receives propelled air from the air propelling unit, and includes an airfoil designed to locally reduce pressure and temperature, thereby promoting water vapor condensation within the received propelled air. The fog harvester receives the propelled air with condensed water from the water condensation unit and collects the condensed water.

### CROSS REFERENCE TO RELATED APPLICATIONS/INCORPORATION BY REFERENCE STATEMENT

This application claims priority to U.S. Provisional Application 63/193,826 filed May 27, 2021, the entire contents of which are hereby expressly incorporated herein by reference.

### BACKGROUND OF THE INVENTIVE CONCEPTS

### 1. Field of the Inventive Concepts

The present disclosure relates to methods and systems for harvesting water from air and, more particularly, to methods and systems for water vapor condensation and collection.

### 2. Brief Description of Related Art

Air contains a certain amount of water vapor, the gaseous phase of water. The amount of water vapor any mass of air can contain depends on the temperature of that air such that the warmer the air is, the more water it can hold. There is approximately as much fresh water in the atmosphere as there is on the surface of the Earth. Table 1 below shows saturation water content in air as a function of temperature. In particular, Table 1 indicates maximum moisture content (saturation) in a cubic meter of air at various temperatures wherein 10⁻³ kg/m³=1 g/m³.

TABLE 1
Saturation water content in air as a function of temperature.

| | |
|---|---|
| Temperature | Max. Water Content |

| (° C.) | (° F.) | (10⁻³ kg/m³) | (10⁻³ lb/ft³) |
|---|---|---|---|
| −25 | −13 | 0.64 | 0.04 |
| −20 | −4 | 1.05 | 0.066 |
| −15 | 5 | 1.58 | 0.099 |
| −10 | 14 | 2.31 | 0.14 |
| −5 | 23 | 3.37 | 0.21 |
| 0 | 32 | 4.89 | 0.31 |
| 5 | 41 | 6.82 | 0.43 |
| 10 | 50 | 9.39 | 0.59 |
| 15 | 59 | 12.8 | 0.8 |
| 20 | 68 | 17.3 | 1.07 |
| 30 | 86 | 30.4 | 1.9 |
| 40 | 104 | 51.1 | 3.2 |
| 50 | 122 | 83 | 5.2 |
| 60 | 140 | 130 | 8.1 |

According to the American Meteorological Society, fog is defined as atmosphere-suspended water droplets within the vicinity of the surface of the Earth that affect visibility. Visibility reduction in fog depends on the concentration of cloud condensation nuclei and the resulting distribution of droplet sizes. Fog differs from cloud only in that the base of fog is at the surface of the Earth, while clouds are above the surface.

Fog collection refers to the collection of water from fog using, for example, large pieces of vertical canvas, or nets comprised of fine weave mesh, to make the fog-droplets flow down towards a trough where the liquid water is collected. These are commonly referred to as fog fences, or fog harps, and the like.

The dew point is the temperature at which the water vapor in a sample of air at constant pressure condenses into liquid water at the same rate at which it evaporates. At temperatures below the dew point, the rate of condensation is greater than that of evaporation, forming more liquid water. Isobaric heating or cooling of a volume of air does not alter the dewpoint, so long as no vapor is added or removed as shown in FIG. 1.

Fog begins to form when water vapor condenses into tiny liquid water droplets that are suspended in the air. Generally speaking, fog forms when the difference between the air temperature and the dew point is less than 2.5° C. (4.5° F.). This may occur through cooling of the air to a little below its dewpoint, or by adding moisture and thereby elevating the dewpoint. Given a relative humidity near 100%, fog occurs from either added moisture in the air, or falling ambient air temperature. At 100% relative humidity, the air cannot hold additional moisture, thus, the air will become supersaturated if additional moisture is added or the temperature drops further below the dewpoint. Drizzle occurs when the humidity of fog attains 100% and the minute cloud droplets begin to coalesce into larger droplets. This can occur when the fog layer is cooled sufficiently, or when it is forcibly compressed from above by descending air.

If all the other factors influencing humidity remain constant, the relative humidity rises with falling temperature because less water vapor is needed to saturate the air. Water vapor will condense onto another surface that is cooler than the dew point temperature, or when the water vapor equilibrium in air has been exceeded. This phenomenon is most observable on thin, flat, exposed objects including plant leaves and blades of grass. As the exposed surface cools by radiating its heat to the sky, atmospheric moisture condenses at a rate greater than that of which it can evaporate, resulting in the formation of water droplets.

Technologies to remove water from air are known, such as Carnot cycle air conditioners or dehumidifiers. Dehumidifiers operate by passing air over or through a set of coils the temperature of which are reduced below ambient temperature. Cooling of the air reduces its capacity for carrying water vapor, resulting in condensation. The rate of water production depends on the ambient temperature, humidity, the volume of air passing through or over the coils, and the capacity of the machine to cool the coils.

Such known technologies to remove water from air are generally costly and energy intensive. Lower cost and more energy-efficient methods and systems for recovering water from air would be desirable.

### SUMMARY OF THE INVENTIVE CONCEPTS

The inventive concepts disclosed herein relate generally to methods and systems for harvesting water from air. In one embodiment, integrated system for harvesting water from air, the system includes an air propelling unit, a water condensation unit, and a fog harvester. The water condensation unit receives propelled air from the air propelling unit, and includes an airfoil designed to locally reduce pressure and temperature, thereby promoting water vapor condensation within the received propelled air. The fog harvester receives the propelled air with condensed water from the water condensation unit and collects the condensed water.

In another embodiment, a method for harvesting water vapor from air embodies the following steps. Air containing water vapor is passed over an airfoil designed to locally reduce pressure and temperature. The air reaches the airfoil at a velocity sufficient to promote water vapor condensation. The resulting air with water droplets is directed to a fog harvester for collection of the water.

### BRIEF DESCRIPTION OF THE DRAWINGS

The accompanying drawings, which are incorporated in and constitute a part of this specification, illustrate one or more implementations described herein and, together with the description, explain these implementations. The drawings are not intended to be drawn to scale, and certain features and certain views of the figures may be shown exaggerated, to scale or in schematic in the interest of clarity and conciseness. Not every component may be labeled in every drawing. Like reference numerals in the figures may represent and refer to the same or similar element or function. In the drawings:

FIG. 1 is a graphical representation of dew point as a function of relative humidity and temperature.

FIG. 2 is an illustrative cross-section of a cambered airfoil.

FIG. 3 is an exemplary schematic illustration of an atmospheric water harvesting system in accordance with the present disclosure.

FIG. 4 is an illustrative example of water vapor condensation above an airfoil due to formation of a region of low pressure and low temperature above the airfoil. The region of reduced temperature above the airfoil is below that of ambient dewpoint resulting in condensation of atmospheric water vapor.

FIG. 5 is a diagrammatic view illustrating Kutta-Joukowski lift with the force on a cylinder due to cylinder rotation within a stream of air or fluid.

FIG. 6 illustrates use of an impervious surface to separate the region in which the rotation direction of the cylinder is moving with incident airflow creating an area of lower pressure and hence lower temperature, from that region in which the rotation direction of the cylinder would be against incident airflow creating an area of higher pressure and hence higher temperature.

FIG. 7 illustrates use of multiple cascaded Magnus-effect rotating cylinders for enhanced temperature reduction.

FIG. 8A illustrates of cylinder used to obtain a 10° F. drop in temperature. Grid squares indicate 10 mm by 10 mm. The cross-sectional dimensions of the cylinder, to the outer tip, are 159.2 mm×159.2 mm; the length of the cylinder is 334.2 mm.

FIG. 8B is a perspective view of the cylinder in FIG. 8A.

FIG. 9 illustrates the geometry of a counterflow Ranque-Hilsch vortex tube.

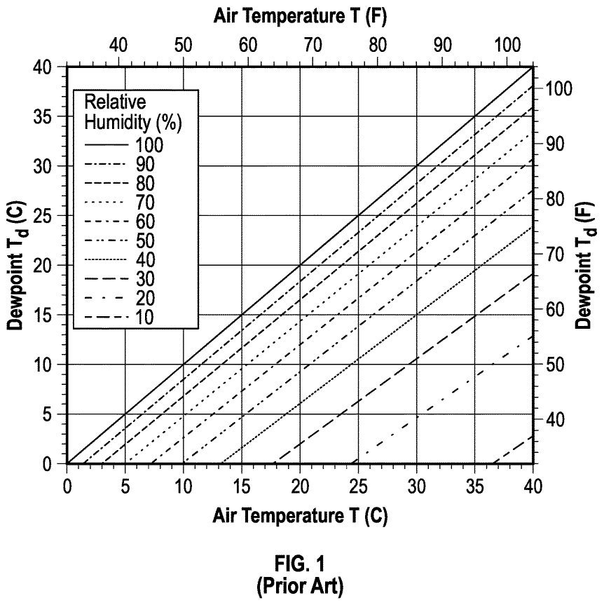

### DETAILED DESCRIPTION

Before explaining at least one embodiment of the inventive concept(s) in detail by way of exemplary language and results, it is to be understood that the inventive concept(s) is not limited in its application to the details of construction and the arrangement of the components set forth in the following description. The inventive concept(s) is capable of other embodiments or of being practiced or carried out in various ways. As such, the language used herein is intended to be given the broadest possible scope and meaning; and the embodiments are meant to be exemplary and not exhaustive. Also, it is to be understood that the phraseology and terminology employed herein is for the purpose of description and should not be regarded as limiting.

Unless otherwise defined herein, scientific and technical terms used in connection with the presently disclosed inventive concept(s) shall have the meanings that are commonly understood by those of ordinary skill in the art. Further, unless otherwise required by context, singular terms shall include pluralities and plural terms shall include the singular. The foregoing techniques and procedures are generally performed according to conventional methods well known in the art and as described in various general and more specific references that are cited and discussed throughout the present specification.

All patents, published patent applications, and non-patent publications mentioned in the specification are indicative of the level of skill of those skilled in the art to which this presently disclosed inventive concept(s) pertains. All patents, published patent applications, and non-patent publications referenced in any portion of this application are herein expressly incorporated by reference in their entirety to the same extent as if each individual patent or publication was specifically and individually indicated to be incorporated by reference.

All of the compositions, assemblies, systems, and/or methods disclosed herein can be made and executed without undue experimentation in light of the present disclosure. While the compositions, assemblies, systems, and methods of the inventive concept(s) have been described in terms of particular embodiments, it will be apparent to those of skill in the art that variations may be applied to the compositions and/or methods and in the steps or in the sequence of steps of the methods described herein without departing from the concept, spirit, and scope of the inventive concept(s). All such similar substitutions and modifications apparent to those skilled in the art are deemed to be within the spirit, scope, and concept of the inventive concept(s) as defined by the appended claims.

As utilized in accordance with the present disclosure, the following terms, unless otherwise indicated, shall be understood to have the following meanings:

The use of the term “a” or “an” when used in conjunction with the term “comprising” in the claims and/or the specification may mean “one,” but it is also consistent with the meaning of “one or more,” “at least one,” and “one or more than one.” As such, the terms “a,” “an,” and “the” include plural referents unless the context clearly indicates otherwise. Thus, for example, reference to “a compound” may refer to one or more compounds, two or more compounds, three or more compounds, four or more compounds, or greater numbers of compounds. The term “plurality” refers to “two or more.”

The use of the term “at least one” will be understood to include one as well as any quantity more than one, including but not limited to, 2, 3, 4, 5, 10, 15, 20, 30, 40, 50, 100, etc. The term “at least one” may extend up to 100 or 1000 or more, depending on the term to which it is attached; in addition, the quantities of 100/1000 are not to be considered limiting, as higher limits may also produce satisfactory results. In addition, the use of the term “at least one of X, Y, and Z” will be understood to include X alone, Y alone, and Z alone, as well as any combination of X, Y, and Z. The use of ordinal number terminology (i.e., “first,” “second,” “third,” “fourth,” etc.) is solely for the purpose of differentiating between two or more items and is not meant to imply any sequence or order or importance to one item over another or any order of addition, for example.

The use of the term “or” in the claims is used to mean an inclusive “and/or” unless explicitly indicated to refer to alternatives only or unless the alternatives are mutually exclusive. For example, a condition “A or B” is satisfied by any of the following: A is true (or present) and B is false (or not present), A is false (or not present) and B is true (or present), and both A and B are true (or present).

As used herein, any reference to “one embodiment,” “an embodiment,” “some embodiments,” “one example,” “for example,” or “an example” means that a particular element, feature, structure, or characteristic described in connection with the embodiment is included in at least one embodiment. The appearance of the phrase “in some embodiments” or “one example” in various places in the specification is not necessarily all referring to the same embodiment, for example. Further, all references to one or more embodiments or examples are to be construed as non-limiting to the claims.

Throughout this application, the term “about” is used to indicate that a value includes the inherent variation of error for a composition/apparatus/device, the method being employed to determine the value, or the variation that exists among the study subjects. For example, but not by way of limitation, when the term “about” is utilized, the designated value may vary by plus or minus twenty percent, or fifteen percent, or twelve percent, or eleven percent, or ten percent, or nine percent, or eight percent, or seven percent, or six percent, or five percent, or four percent, or three percent, or two percent, or one percent from the specified value, as such variations are appropriate to perform the disclosed methods and as understood by persons having ordinary skill in the art.

As used in this specification and claim(s), the words “comprising” (and any form of comprising, such as “comprise” and “comprises”), “having” (and any form of having, such as “have” and “has”), “including” (and any form of including, such as “includes” and “include”), or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AAB, BBC, AAABCCCC, CBBAAA, CABABB, and so forth. The skilled artisan will understand that typically there is no limit on the number of items or terms in any combination, unless otherwise apparent from the context.

As used herein, the term “substantially” means that the subsequently described event or circumstance completely occurs or that the subsequently described event or circumstance occurs to a great extent or degree. For example, when associated with a particular event or circumstance, the term “substantially” means that the subsequently described event or circumstance occurs at least 80% of the time, or at least 85% of the time, or at least 90% of the time, or at least 95% of the time. For example, the term “substantially adjacent” may mean that two items are 100% adjacent to one another, or that the two items are within close proximity to one another but not 100% adjacent to one another, or that a portion of one of the two items is not 100% adjacent to the other item but is within close proximity to the other item.

As used herein, the phrases “associated with” and “coupled to” include both direct association/binding of two moieties to one another as well as indirect association/binding of two moieties to one another. Non-limiting examples of associations/couplings include covalent binding of one moiety to another moiety either by a direct bond or through a spacer group, non-covalent binding of one moiety to another moiety either directly or by means of specific binding pair members bound to the moieties, incorporation of one moiety into another moiety such as by dissolving one moiety in another moiety or by synthesis, and coating one moiety on another moiety, for example.

As used herein, the term “air” is used in its broadest sense and includes, for instance, air-gas mixtures, air-vapor, and air-fog mixtures.

As used herein, the term “airfoil” is a structure with curved surfaces designed to give the most favorable ratio of lift to drag in flight, used as the basic form of the wings, fins, and horizontal stabilizer of most aircraft.

Generally, the inventive systems and methods provided herein are configured to achieve significant reductions in air temperature to promote water vapor condensation with subsequent collection of the liquid droplets as exemplified in FIG. 3. A system 10 for harvesting water from air comprises a water condensation unit 12, a unit 14 for propelling air to a high velocity, and a water collection unit 16. The water condensation unit 12 includes an air guiding section 18 and a static or dynamic airfoil 20. High velocity air from unit 14 enters the air guiding section 18 of the water condensation unit 12, and the cooled air with suspended water droplets is directed into the water collection unit 16, also referred to as a fog harvester.

With respect to atmospheric water harvesting, renewable energy sources such as wind-turbines or photovoltaics can be used to generate electricity, which in turn can be used to collect and compress air that can be passed over a static airfoil at high velocity, or over a spinning sphere or cylinder per the Magnus effect, to achieve a reduction in temperature at fixed humidity thus promoting water condensation. Subsequent collection of the condensate can be achieved in a water collection unit or fog harvester, fog net and/or fog harp.

It is a further aspect of the systems and methods described herein to provide configurations for compressed air of a given temperature to be passed through a vortex tube for separation into hot and cold temperature streams, with the cold-stream output then passed, as desired, over a fixed airfoil or Magnus effect device for an additional drop in temperature by which water vapor is condensed to a liquid and then collected. The vortex tube can be simultaneously utilized for separating and thus concentrating and/or removing CO₂ from air, with the cold temperature stream used for atmospheric water harvesting.

In some embodiments, one or more airfoils may be used to promote water vapor condensation with subsequent collection of the liquid droplets. Generally, passing through air at high velocity, the one or more airfoils may be configured to create a region of lower pressure above the airfoil to provide lift, with the same effect achieved by passing high velocity air over a stationary airfoil. By the ideal gas law, the lower pressure region in turn results in a region of lower temperature that can, depending upon gas-phase water content and temperature, be used to condense the gas-phase water vapor to make a fog comprised of many small droplets of liquid water that can be readily collected (e.g., fog harvesters, fog harps and/or fog nets). In some embodiments, harvesting water vapor from air by passing water vapor containing air over the airfoil configured to locally reduce pressure and through the ideal gas law temperature may be at an air velocity equal to or greater than 24 m/s. In some embodiments, operating air velocity may be obtained through the use of one or more fans configured to impart velocity to the air molecules. In some embodiments, the one or more fans may be operated using electricity obtained using renewable sources (e.g., photovoltaics, wind turbines, or the like). In some embodiments, operating air velocity may be altered by release of compressed air (e.g., passing from high to lower ambient pressures). In some embodiments, one or more canvas sheets, fog nets, fog harps or the like may be positioned at or adjacent to the rear end of the airfoil to maximize water harvesting. In some embodiments, a portion or all of the collected water may be housed in a storage container.

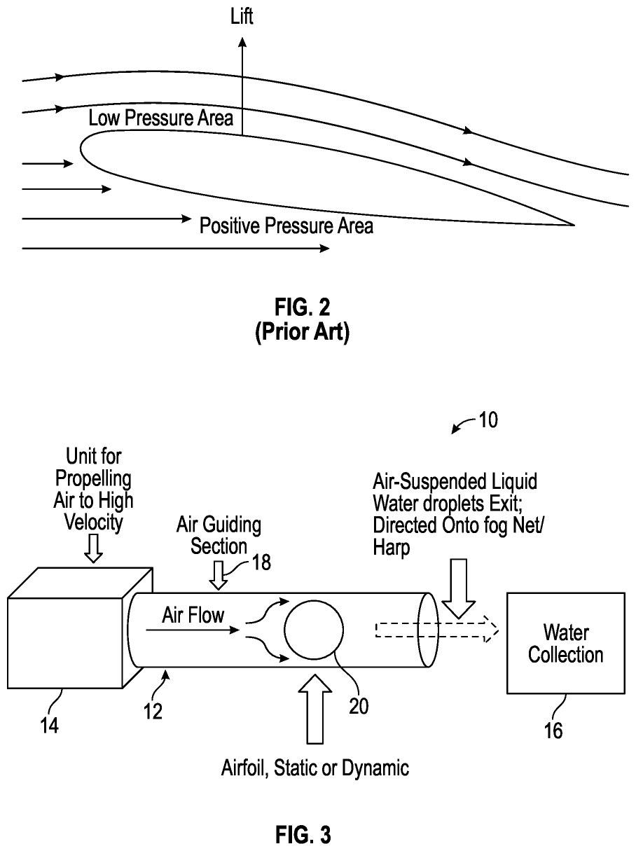

Referring back to FIG. 2, cambered airplane wings, or airfoils, provide lift by creating a region of low pressure above the wing and higher pressure below the wing. Since the pressure below the wing is higher than the pressure above the wing there is a net upwards force, or lift. In some embodiments, the airfoil may be formed of plastic and/or metal. Inclining the airfoil at an angle relative to the air flow, the so-called angle of attack, increases lift, up to a limit of approximately 10° to 15° where the air flow separates from the airfoil in that it no longer follows the contour of the airfoil surface.

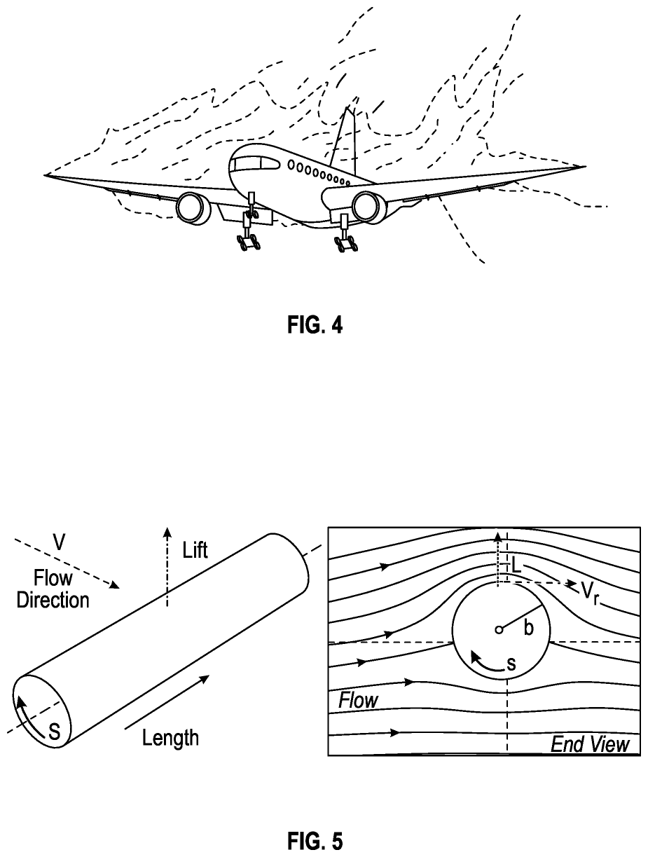

With all else constant, by the ideal gas law it is known that a change in pressure is accompanied by a change in temperature. Consequently, the region of reduced pressure formed above an airfoil, due to the airfoil passing through air or the air passing over the fixed airfoil, is also a region of reduced temperature. If this region of reduced temperature has a temperature below the dewpoint temperature, then water vapor in this region will condense to form liquid water droplets. It is not uncommon for aircraft, moving at speed through warm humid air, to create visible clouds of fog as illustrated by FIG. 4.

For example, and with reference to the work of Karabelas and Markatos [S. J. Karabelas, N. C. Markatos, water vapor condensation in forced convection flow over an airfoil, Aerospace Science and Technology 12 (2008) 150-158], the authors model the flow of humid air over a Clark-y-type airfoil of 1 m chord length. As understood by those skilled in the art, the chord is an imaginary straight line joining the leading edge and trailing edge of an airfoil. The chord length is the distance between the trailing edge and the point where the chord intersects the leading edge. In one example, for an air speed of 460 mph, relative humidity 70%, temperature 20° C., 0° angle of attack, the temperature falls to a minimum of 2° C. approximately 0.2 m from the leading edge, a temperature well below that of the 14° C. dewpoint temperature. Maximum water concentration exists at the trailing edge of the airfoil, with the liquid concentration or fog vanishing, returning to the vapor state, after 10-15 m. Increasing the angle of attack results in a greater temperature drop above the airfoil and a significant increase in water condensation (water droplet volume fraction). Higher humidity levels require less of a temperature drop for condensation, corresponding to the requirement of lower relative velocities between air stream and airfoil.

An embodiment, partially shown in FIG. 5, achieves a reduction in pressure and hence temperature, thereby promoting condensation of water vapor, uses the Magnus effect that is associated with a spinning, or rotating, object (sphere or cylinder) within an air, or more generally fluid stream. (For background see, for example, H. M. Barkla, L. J. Auchterloniet, The Magnus or Robins effect on rotating spheres, J. Fluid Mechanics 47 (1971) 437-447.) In some embodiments, a sphere or cylinder spinning about its axis within a directional air stream will preferentially ‘push’ the air in one direction, the direction of rotation, by which regions of lower and higher pressure (lifting force) are generated through a downward deflection of the airflow.

FIG. 5 illustrates a cylinder of radius b (m), with circular end plates, spinning within a flow stream of direction and magnitude V (m/s) and density ρ (kg/m³); s denotes both the direction of spin and its magnitude in revolutions/second. The lift on the cylinder per unit length L, manifest in a differential pressure, is the product of the fluid velocity and density incident upon the cylinder, and the strength of the vortex that is established by cylinder rotation G:

L=ρVG

Vortex strength G is given by:

G=2πb·(cylinder radial velocity=2πb·s)

G=(2πb)²·s

Thus, force for unit lift on the cylinder is:

L=ρV(2πb)²·s

FIG. 5 indicates a clock-wise rotating cylinder, air flow over the top of the cylinder is assisted by cylinder rotation, i.e., induced flow, while air flow below the cylinder is opposed by the induced flow. The rotation of the cylinder produces an upward force, as indicated in the figure, due to the difference in pressure on the two sides of the cylinder. As known, through the ideal gas law, with all else constant a reduction in pressure corresponds to a reduction of temperature by which water vapor can be condensed to form liquid droplets.

Our concern is the not the absolute lift generated on the cylinder, but rather the temperature drop within a region of reduced pressure on one side of the spinning cylinder. Use of a rotating cylinder, or sphere, within an air/water flow stream enables one to achieve a given reduction in pressure and thus, as known through the ideal gas law, a corresponding reduction in temperature. The lift, or pressure differential, is a function of fluid flow velocity and density, the square of the cylinder radius, and velocity of cylinder rotation. Some experimental data on pressure changes inherent to Magus rotor operation can be found in [M. C. Miller, Wind-Tunnel Measurements of the Surface Pressure Distribution on a Spinning Magnus Rotor. J. Aircraft 16 (1979) 815-822]. Further, the surface of the cylinder can be designed to include scoops, vanes, waves or ridges, or other similar structures, to promote air movement across the cylinder surface.

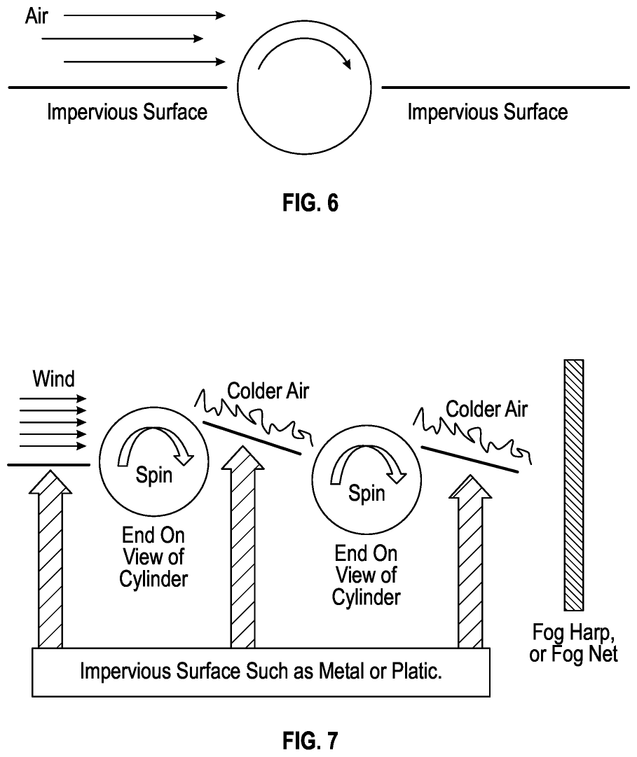

Use of a rotating cylinder or sphere within an air/water flow stream may enable a given reduction in pressure, and corresponding reduction in temperature, at lower fluid flow velocities since the lift, or pressure differential, is a linear function of both fluid flow velocity and cylinder rotation. In one embodiment, air is directed on only one side of the rotating cylinder or sphere, namely the side of the cylinder rotating in the direction of air flow as illustrated in FIG. 6. The air may be guided by use of an impervious surface such as, for example, a plastic or metal sheet. The advantage of this technique is that the majority of the air is utilized in creating a region or relatively low pressure and hence low temperature region.

In some embodiments, water vapor containing air is passed over a spinning sphere or cylinder to locally reduce pressure, and through the ideal gas law temperature, with air flow and spin velocities configured to promote water vapor condensation, resulting water droplets are subsequently collected (e.g., fog harvesters, fog harps and/or fog nets). In some embodiments, the sphere or cylinder may have a rotational velocity equal to or greater than 100 revolutions/minute. In some embodiments, an electric motor may be used to spin the sphere and/or cylinder. In some embodiments, one or more fans may provide velocity to air molecules. In some embodiments, at least one of the one or more fans may include two or more vanes. In some embodiments, the vanes may be formed of plastic. In some embodiments, the one or more fans may be operated using electricity obtained using renewable sources (e.g., photovoltaics, wind turbines, and/or the like). In some embodiments, velocity to air molecules may be provided via compressed air via passing from higher to lower ambient pressures. In some embodiments, a portion or the entirety of collected water may be stored in a storage tank.

A series or parallel arrangement of airfoils, such as rotating cylinders or spheres, can be used to achieve a further drop in temperature as illustrated in FIG. 7, thus promoting enhanced water condensation. The air within the region of lower pressure is directed, by the use of guiding surfaces, onto the next airfoil to promote a further reduction in pressure and thus temperature.

In some embodiments, one or more vortex tubes may be used to promote water vapor condensation with subsequent collection of the liquid droplets. Generally, the one or more vortex tubes may be configured to divide a high-pressure input flow of given temperature into two low-pressure flows, one of elevated and one of reduced temperature, to achieve the temperature drop needed to condense gas-phase water vapor, with subsequent collection of the water droplets (e.g., via fog harvesters, fog nets and/or fog harps). The one or more vortex tubes can operate as a dual use technology, with simultaneous separation of CO₂ from air and, utilizing the cold-exit output, condensation of water vapor for collection of liquid water. In some embodiments, the vortex tube may be formed of plastic or metal material. In some embodiments, the vortex tube may be formed via a three-dimensional printer.

To provide for condensation, a high-pressure fluid stream of given temperature entering the one or more vortex tubes may be separated into two streams of lower pressure, one of high temperature and one of low temperature. As dependent upon the specific design of the vortex tube and operating parameters, such as input pressure and mass fraction leaving one exit or the other, there can be a significant difference between input temperature and the hot/cold-exit output temperatures. Depending on ambient temperature and humidity, and design of the vortex tube, the cold-exit output temperature may be sufficiently below the dew point temperature to readily condense the water vapor.

In some embodiments, the cold-exit output stream of the vortex tube can be directed over an airfoil, be it cambered wing shape, spinning sphere, or spinning cylinder, to achieve a further reduction in ambient temperature by which further water vapor condensation is promoted. In some embodiments, the cold-exit output stream of the vortex tube can be directed into a subsequent vortex tube configured to further lower the cold-exit temperature with water droplets formed upon water condensation subsequently collected (e.g., fog nets, fog harps, fog harvesters). In some embodiments, at least a portion or all of the water collected may be stored in one or more storage tanks. In some embodiments, electricity used to operate the system may be obtained via one or more renewable energy sources (e.g., photovoltaics, wind turbines, and/or the like).

Generally, compressed air is used during operation of the one or more vortex tubes. As shown in Table 1 above, compressed air retains water vapor content unless the compressed air is reduced in temperature, in which case the system effectively works as a pressurized dehumidifier. However, with respect to water harvesting, there is no advantage to retaining compressed air, but rather once compressed it should be passed over an airfoil at high velocity to promote condensation, or over a spinning cylinder or sphere to promote condensation, or through a vortex tube to promote condensation, or through a combination vortex tube and airfoil unit to promote condensation. Once the water vapor is condensed into a fog, various known techniques of fog harvesting can be employed (e.g., fog harvesters, fog nets, fog harps). In some embodiments, compressed air may be input into the vortex tube, with a comparatively heavy CO₂ molecule exiting the cold temperature exit with any condensed water vapor leaving the cold temperature exit in the form of droplets captured by passing an exit stream through a fog net or fog harvester. The gaseous CO₂ may then be converted into another chemical species or temporarily stored.

In the following examples, specific equipment and test conditions are described. However, the present inventive concept(s) is not limited in its application to the specific experimentation, results and laboratory procedures. Rather, the Examples are simply provided as proof of concept and as one of various embodiments and are meant to be exemplary, not exhaustive.

### Example 1

In this example, we tested water condensation through use of a Magnus Rotor. The 40 V dc electric motor of a BLACK & DECKER™ CM1640 Cordless Lawn Mower, which is properly used to spin the grass-cutting blade with a nominal rotation speed of 3000 rpm, was used to rotate a cylinder by which a Magnus effect, that is a differential pressure between two sides of a rotating cylinder, was achieved. The cylinder had a PVC pipe section of approximately 24 in length, having a nominal 10 in diameter; both ends of the cylinder were closed with a circular 0.5 in thick plywood plug, cut to tightly fit the interior diameter of the PVC pipe. The plywood plugs were bound to the PVC cylinder by the use of wood screws passing through the PVC cylinder into the wood; the heads of the screws were flush with the surface of PVC cylinder. A 36 in long 0.5 in diameter aluminum rod, connected to the hub of the 40 V electric motor, was passed through the central axis of the cylinder and bound to each of the plywood plugs through the use of four compression fittings, one on each side of each plywood plug. On the one end the aluminum rod axis was held in place by the mower housing, turned on its side and balanced, while the other end was supported by a U-bolt lubricated by lithium grease. At 3000 rpm the nominal surface velocity of the cylinder is approximately 77 mph.

A BLACK & DECKER™ BEBL750 Electric Blower, with a nominal manufactured rated nozzle output velocity, on the low setting, of approximately 120 mph was used to direct an air stream over the rotating cylinder in outdoor experiments conducted in Raleigh, N.C., August 2020, when ambient conditions were approximately 95% relative humidity and 85° F. Under these specific conditions, with the output nozzle of the blower held several (unmeasured) inches from the surface of the spinning cylinder, the pressure differential, and corresponding temperature drop, was sufficient to condense atmospheric water vapor so that a stream of fog was visibly emitted from the surface of the rotating (Magnus) cylinder. The objective was a proof-of-concept demonstration; neither the temperature drop nor fraction of the water vapor condensed were measured.

### Example 2

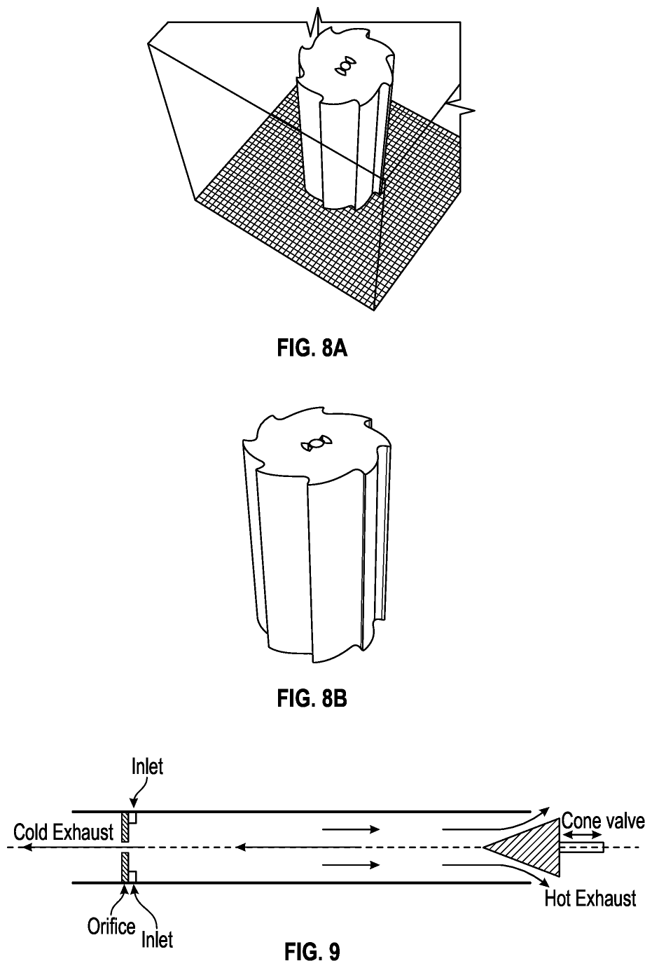

Water condensation through use of a Magnus Rotor was again tested using a 56 V battery to spin a cylinder of the design shown in FIGS. 8A and 8B at a nominal speed of 3200 rpm. The radius of the cylinder, the radial distance from the cylinder axis to the outer tip of the wave, or saw blade-like scoops, is 159.2 mm; the length of the cylinder is 334.2 mm. A BLACK & DECKER™ BEBL750 Electric Blower, with a nominal rated nozzle output velocity, on the low setting, of 120 mph, was used to direct air over the rotating cylinder, oriented such that the scoop was turning in the direction of incident wind. The velocity of the air incident upon the rotating cylinder was estimated at approximately 35 mph. In outdoor experiments conducted in Sugar Hill, Ga., April 2022, from an ambient temperature of approximately 84 F, the low-pressure region temperature was measured, by use of an IR camera, to be nearly 74° F.

### Example 3

Another approach to reducing ambient temperature below the water vapor condensation point, thus enabling collection of condensed water vapor, is by the use of a Ranque-Hilsch vortex tube (RHVT) [See for example: R. Hilsch, The use of the expansion of gases in a centrifugal field as cooling process. Review Scientific Instruments 18 (1947) 108-113. L. A. Fekete, Vortex tube process and apparatus, U.S. Pat. No. 3,546,891 (1970)].

Referring to FIG. 9, a high-pressure fluid stream of given temperature entering a RHVT will be separated into two streams of lower pressure, one of higher temperature and one of lower temperature. As dependent upon the specific design of the RHVT and operating parameters, such as input pressure and mass fraction leaving one exit or the other, there can be a significant difference between input temperature and the hot/cold output temperatures. Depending on ambient temperature and humidity, and design of the RHVT, the cold-exit output temperature may be sufficiently below the dew point temperature to readily condense the water vapor. Herein we teach a prophetic example of a cold-exit output stream of a RHVT over an airfoil, be it cambered wing shape or spinning cylinder or sphere, to achieve a further reduction in ambient temperature by which water vapor condensation is promoted.

It is worth noting, as a point of clarification given the application of condensing water vapor from air, that compressed air is required for operation of a RHVT. Compressed air will retain its water vapor content unless the compressed air is reduced in temperature, see Table 1 above, in which case the system effectively works as a pressurized dehumidifier. With respect to water harvesting, as taught, it is necessary to use or impart air of significant velocity, such as that accomplished with electric motor drive fans, or the compression of air and subsequent release through a small aperture. Regarding compressed air, in this application there is no advantage to retaining or storing compressed air, but rather once compressed it should be released, at suitable velocity, over an airfoil to promote water vapor condensation, or through a RHVT to promote condensation, or through a combination RHVT and airfoil unit to promote condensation. Once the water vapor is condensed into liquid droplet form various known techniques of water droplet, or fog, harvesting can be employed to obtain liquid water, such as a fog harp or fog net.

From the above description, it is clear that the inventive concepts disclosed and claimed herein are well adapted to carry out the objects and to attain the advantages mentioned herein, as well as those inherent in the invention. While exemplary embodiments of the inventive concepts have been described for purposes of this disclosure, it will be understood that numerous changes may be made which will readily suggest themselves to those skilled in the art and which are accomplished within the spirit of the inventive concepts disclosed and claimed herein.

### REFERENCES CITED

R. Hilsch, The use of the expansion of gases in a centrifugal field as cooling process. Rev. Sci. Instruments 18 (1947) 108-113.
L. A. Fekete, Vortex tube process and apparatus, U.S. Pat. No. 3,546,891 (1970).
S. J. Karabelas, N. C. Markatos, Water vapor condensation in forced convection flow over an airfoil. Aerospace Science and Technology 12 (2008) 150-158
H. M. Barkla, L. J. Auchterloniet, The Magnus or Robins effect on rotating spheres. J. Fluid Mechanics 47 (1971) 437-447
M. Fessehaye, S. A. Abdul-Wahab, M. J. Savage, T. Kohler, T. Gherezghiher, H. Hurni. Fog-water collection for community use Renewable and Sustainable Energy Reviews 29 (2014) 52-62.
W. Shi, M. J. Anderson, J. B. Tulkoff, B. S. Kennedy, J. B. Boreyko, Fog Harvesting with Harps. ACS Appl. Mater. Interfaces 2018, 10, 11979-11986

What is claimed is:

1. An integrated system for harvesting water from air, the system comprising:
an air propelling unit;
a water condensation unit receiving propelled air from the air propelling unit, and comprising an airfoil designed to locally reduce pressure and temperature, thereby promoting water vapor condensation within the received propelled air; and
a fog harvester receiving propelled air with condensed water from the water condensation unit.

2. The integrated system of claim 1, wherein the air propelling unit comprises one or more fans.

3. The integrated system of claim 1, wherein the air propelling unit comprises compressed air releasable via a nozzle.

4. The integrated system of claim 1, wherein the air propelling unit comprises one or more fans or air compressors powered by electricity or fossil fuel combustion.

5. The integrated system of claim 1, wherein the water condensation unit comprises a cambered airfoil having an airfoil chord to airstream angle of between 0° and 25°.

6. The integrated system of claim 1, wherein the airfoil is constructed of a material selected from the group consisting of plastic, ceramic, polylactic acid, epoxy-resin, wood, metal, and combinations thereof.

7. The integrated system of claim 1, wherein the water condensation unit comprises multiple airfoils.

8. The integrated system of claim 1, wherein the propelled air from the air propelling unit is directed onto the airfoil with a structure constructed at least in part of a material selected from the group consisting of plastic, ceramic, polylactic acid, epoxy-resin, wood, metal, and combinations thereof.

9. The integrated system of claim 1, wherein the propelled air with condensed water from the water condensation unit is directed to the fog harvester with a structure constructed at least in part of a material selected from the group consisting of plastic, ceramic, wood, metal, and combinations thereof.

10. The integrated system of claim 1, wherein the fog harvester is selected from the group consisting of fog harps, fog nets, fog tarps, and combinations thereof.

11. The system of claim 1, wherein the fog harvester is positioned adjacent to or within 12 m of an exit end of the water condensation unit.

12. The integrated system of claim 1, further comprising a water storage unit receiving water from the fog harvester.

13. The integrated system of claim 1, wherein the airfoil comprises a Magnus rotor selected from the group consisting of a Magnus rotor airfoil, a spinning sphere, a spinning cylinder, and combinations thereof.

14. The integrated system of claim 13, further comprising fans, air compressors, or both, sized to provide an air velocity to the Magnus rotor of at least 35 mph, the fans or air compressors powered using electricity, fossil fuel combustion, air pressure, water pressure, or combinations thereof.

15. The integrated system of claim 14, wherein the fans have one or more vanes.

16. The integrated system of claim 13, wherein the Magnus rotor comprises a smooth surface or a textured surface topology comprising waves, scoops, ridges, rods, wires, canals, or combinations thereof.

17. The integrated system of claim 13, wherein water condensation unit comprises multiple Magnus rotors oriented in either parallel or sequentially.

18. The integrated system of claim 1, wherein the air propelling unit comprises a compressor, and the water condensation unit further comprises a Ranque Hilsch vortex tube capable of separating the compressed air into hot and cold exit streams, with the cold exit stream being directed over the airfoil.

19. The integrated system of claim 18, wherein the air foil is selected from the group consisting of a cambered airfoil, a spinning sphere, a spinning cylinder, and combinations thereof.

20. A method for harvesting water vapor from air, the method comprising:
passing air containing water vapor over an airfoil designed to locally reduce pressure and temperature, at a velocity sufficient to promote water vapor condensation; and
directing the resulting air with water droplets to a fog harvester and collecting the water.

21. The method of claim 20, wherein the fog harvester is selected from the group consisting of fog nets, fog harps, fog tarps, and combinations thereof.

22. The method of claim 20, wherein the fog harvester is positioned within 12 m of a rear of the airfoil.

23. The method of claim 20, wherein the air containing water vapor is passed over the airfoil at an air velocity equal to or greater than 35 mph.

24. The method of claim 20, further comprising the step of imparting an operating air velocity to the air containing water vapor through use of one or more fans, or by release of compressed air through a nozzle.

25. The method of claim 20, wherein the air containing water vapor is directed over a cambered airfoil having an airfoil chord, and designed with an angle of the airfoil chord and air stream between 0° and 25°.

26. The method of claim 20, further comprising the step of temporarily storing the collected water.

27. The method of claim 20, wherein the airfoil comprises a Magnus rotor selected from the group consisting of a Magnus rotor airfoil, a spinning sphere, and a spinning cylinder.

28. The method of claim 27, wherein air flow and spin velocities are selected to promote water vapor condensation.

29. The method of claim 27, wherein the Magnus rotor has a rotational velocity equal to or greater than 50 revolutions/minute.

30. The method of claim 27, wherein electricity, a combustion engine, or compressed air is used to spin the Magnus rotor.

31. The method of claim 27, wherein a fan or and air compressor is used to impart a velocity of at least 35 mph to the air containing water vapor upon reaching the Magnus rotor, and wherein the fan or the air compressor are powered by electricity, fossil fuel combustion, air pressure, or water pressure.

32. The method of claim 27, wherein the surface of the Magnus rotor is either smooth, or textured with surface features comprising waves, scoops, ridges, rods, wires, canals, or combination thereof.

33. The method of claim 20, further comprising the step of passing compressed air to a Ranque Hilsch vortex tube to produce a hot exit stream and a cold exit stream, wherein the cold exit stream becomes the air containing water vapor directed over the airfoil.

34. The method of claim 33, wherein the air foil comprises a cambered airfoil.

35. The method of claim 33, wherein the airfoil comprises a spinning sphere or a spinning cylinder.
